(19) United States
(12) Patent Application Publication
(10) Pub. No.: US 2024/0241490 A1
(43) Pub. Date: Jul. 18, 2024

(54) INFORMATION PROCESSING APPARATUS, INFORMATION PROCESSING METHOD, AND PROGRAM

(71) Applicant: Nippon Telegraph and Telephone Corporation, Tokyo (JP)

(72) Inventors: Yukitsugu SASAKI, Musashino-shi, Tokyo (JP); Tsuyoshi TOYOSHIMA, Musashino-shi, Tokyo (JP); Kensuke TAKAHASHI, Musashino-shi, Tokyo (JP); Masaru SAKAI, Musashino-shi, Tokyo (JP)

(21) Appl. No.: 18/575,927

(22) PCT Filed: Jul. 27, 2021
(86) PCT No.: PCT/JP2021/027690

§ 371 Date: Jan. 2, 2024

(51) Int. Cl. G05B 15/02

(52) U.S. Cl. CPC G05B 15/02

(57) ABSTRACT

An information processing device includes: a working unit configured to collect and combine various observable data acquired from a managed target at predetermined time intervals; a processing unit configured to input the combined observable data and update a causal structure matrix by repeatedly learning with a generator that generates pseudo-generated data using the causal structure matrix and a discriminator that identifies whether the pseudo-generated data is false or not, wherein the causal structure matrix represents a causal structure between the combined observable data; and an output unit configured to output the causal structure between the observable data based on the causal structure matrix.

### TECHNICAL FIELD

The present invention relates to an information processing device, an information processing method and a program.

### BACKGROUND ART

With the growing importance of integrated services, in which multiple types of services are combined together, there is a growing need to respond to the emergence of new services related to integrated services and changes in the specifications of existing services in a shorter time and at low cost.

An autonomous control loop scheme has been proposed in which work processes are subdivided and individual functions are made into components and made autonomous. The autonomous control loop scheme aims to follow new services and specification changes in existing service in a shorter time and at a low cost. Non Patent Literature 1 disclosed that observable data (log, metrics and trace) is acquired from each operation component of an autonomous control loop scheme and displayed to an operator to identify behaviors of a system employing the autonomous control loop scheme.

### CITATION LIST

### Non Patent Literature

Non Patent Literature 1: Tomoki Ikegaya, Kensuke Takahashi, Satoru Kondo, “Monitoring Method for Improving Observability in Autonomous Management Loop”, 2020 IEICE Society Conference B-14-4, The Institute of Electronics, Information and Communication Engineers, Sep. 17, 2020.

### SUMMARY OF INVENTION

### Technical Problem

However, if only observable data is displayed when a failure occurs, it takes a long time to complete the fault handling because it depends on maintenance personnel finding out the cause of the failure.

The present invention is made on the basis of the above, and an object thereof is to shorten the time required to find out the cause of a failure when it occurs.

### Solution to Problem

An information processing device according to one aspect of the present invention includes: a working unit configured to collect and combine various observable data acquired from a managed target at predetermined time intervals; a processing unit configured to input the combined observable data and update a causal structure matrix by repeatedly learning with a generator that generates pseudo-observable data using the causal structure matrix and a discriminator that identifies whether the pseudo-observable data is false or not, wherein the causal structure matrix represents a causal structure between the combined observable data; and an output unit configured to output the causal structure between the observable data based on the causal structure matrix.

### Advantageous Effects of Invention

According to the present invention, it is possible to shorten the time required to find out the cause of a failure when it occurs.

### BRIEF DESCRIPTION OF DRAWINGS

FIG. 1 is a functional block diagram illustrating an example of a configuration of an information processing device according to the present embodiment.

FIG. 2 is a flowchart illustrating an example of a flow of processing performed by a working unit.

FIG. 3 is a diagram illustrating one example of working processing for observable data.

FIG. 4 is a diagram illustrating a processing unit.

FIG. 5 is a flowchart illustrating an example of a flow of processing performed by an output unit.

FIG. 6A is a diagram illustrating a display example of a causal structure of observable data.

FIG. 6B is a diagram illustrating a display example of a causal structure of observable data.

FIG. 6C is a diagram illustrating a display example of a causal structure of observable data.

FIG. 7 is a diagram illustrating an example of a hardware configuration of the information processing device.

### DESCRIPTION OF EMBODIMENTS

An embodiment of the present invention will be described with reference to the drawings hereinbelow.

### [Configuration]

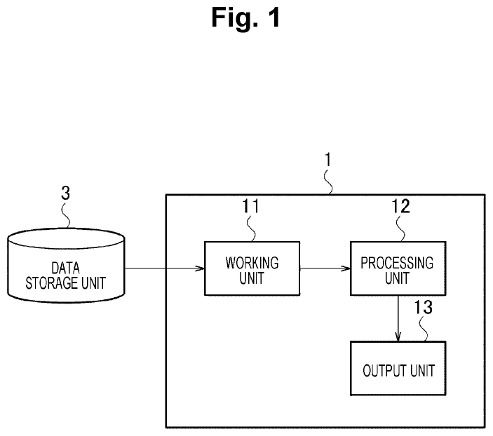

A configuration of an information processing device 1 of the present embodiment will be described referring to FIG. 1. The information processing device 1 illustrated in FIG. 1 inputs observable data (logs, metrics or traces) acquired from a service to be maintained, estimates a causal structure between the observable data, and gets full visibility across the causal structure.

A data storage unit 3 is connected to the information processing device 1. The data storage unit 3 stores the observable data acquired from a managed target. The managed target includes, for example, devices or virtual machines used to provide a service, or software operating on the devices or virtual machines. The observable data may be a character string or numerical data such as a log or a metric that can be acquired from the managed target. The observable data may be acquired from each operation component of the autonomous control loop scheme with the method disclosed in Non Patent Literature 1. The information processing device 1 may include the data storage unit 3 and acquire the observable data from the managed target.

The information processing device 1 includes a working unit 11, a processing unit 12, and an output unit 13.

The working unit 11 acquires the observable data acquired from all the managed targets constituting the service from the data storage unit 3, and processes the observable data of each managed target to combine the observable data of the entire service into a single piece of data. In particular, the working unit 11 rounds timestamp information for each piece of observable data of each managed target at a predetermined interval, and then combines the pieces of observable data having the same timestamp information into a single piece. Accordingly, all the observable data of all the managed targets are collected at the predetermined intervals, and the observable data of the entire service can be subjected to analysis.

The processing unit 12 inputs the observable data of the entire service, performs causal search processing by applying a structural agnostic model (SAM), which is causal search using generative adversarial networks (GANs), and outputs a causal structure matrix as a processing result. The causal structure matrix is a matrix in which types of observable data of the entire service are arranged vertically and horizontally and a causal relationship between the observable data is expressed by a numerical value. The type of observable data indicates which type of data is acquired and from which a managed target. For example, the types of the observable data include a CPU usage of a device A, a memory usage of the device A, a CPU usage of a device B, a memory usage of the device B, and a network usage band of a service C.

The output unit 13 outputs a causal structure between the observable data in a directed acyclic graph (DAG) in which a type of the observable data is represented by a node and a causal relationship is represented by an edge on the basis of the causal structure matrix. For example, the output unit 13 outputs and displays the causal structure between the observable data to a display device such as a display. The output unit 13 may output the causal structure between the observable data to a storage device and store the causal structure in the storage device, or may output the causal structure to another processing device.

### [Operation]

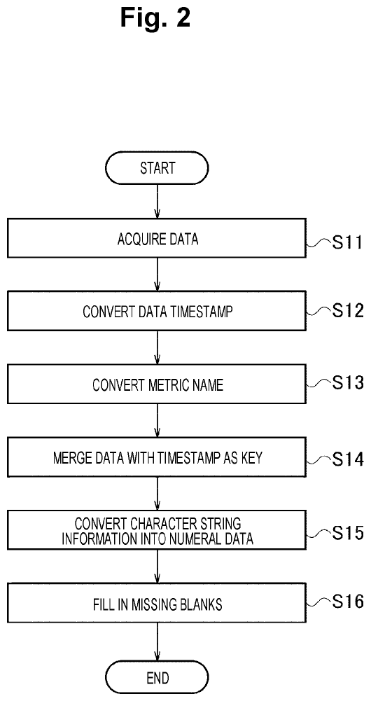

One example of an operation executed by the working unit 11 will be described with reference to a flowchart of FIG. 2.

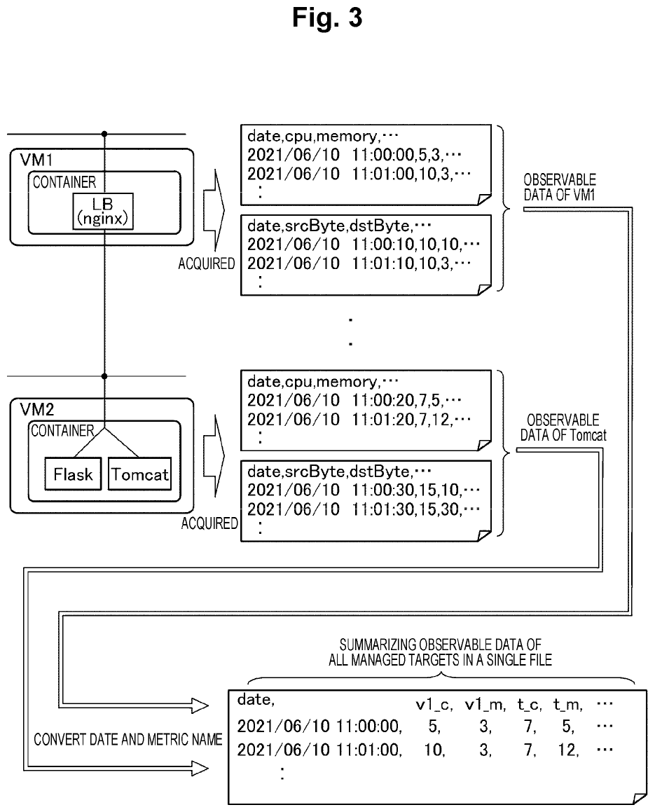

In step S11, the working unit 11 acquires the observable data of all the managed targets constituting the service from the data storage unit 3. In one example of FIG. 3, VM1, VM2, LB, Flask, and Tomcat are illustrated as managed targets. LB runs on VM1 and Flask and Tomcat run on VM2. The data storage unit 3 stores the observable data acquired from these managed targets.

In step S12, the working unit 11 converts the timestamp information for each piece of the observable data on the basis of preset. For example, when the predetermined interval is preset as an interval of 10 seconds, the working unit 11 converts the timestamp information from 11:00:00 to 11:00:09 into 11:00:00, and converts the timestamp information from 11:00:10 to 11:00:19 into 11:00:10. Accordingly, the timestamp information of the observable data is aligned at intervals of 10 seconds.

In step S13, the working unit 11 converts the name of the observable data so that the pieces of data have different names from each other. For example, the working unit 11 connects the managed target name and the metric name by “_”. As a specific example, the working unit 11 converts the CPU usage acquired from VM1 into a metric name such as “VM1_CPU”.

In step S14, the working unit 11 merges the observable data with the timestamp information as a key to generate the observable data of the entire service in which the pieces of observable data are integrated. In particular, the working unit 11 extracts observable data having the same timestamp information from all the observable data, and collects the observable data for each piece of timestamp information. In the example of FIG. 3, the observable data are arranged and combined in the order of “v1_c”, “v1_m”, “t_c”, “t_m”, . . . for each piece of timestamp information, and all the observable data are put together in a single file. “v1_c” represents the CPU usage of VM1, “v1_m” represents the memory usage of VM1, “t_c” represents the CPU usage of Tomcat, and “t_m” represents the memory usage of Tomcat. Since a missing value is handled by processing to be described later, observable data that cannot be acquired at each time may remain missing.

In step S15, the working unit 11 converts the character string information into a numerical value according to rules set in advance. For example, a conversion rule is set to “log level count” for log information such as “ERROR no response”. In a case where three metrics “error, warn, info” are prepared as the metrics, the log corresponds to “error” and thus can be converted into a numerical value of “1, 0, 0”.

In step S16, the working unit 11 handles the missing value of the observable data of the entire service. For example, in a case where traffic does not flow to the network at the time, metrics of network traffic are not acquired, and missingness occurs in as data. For example, approaches to handle missing values include listwise deletion to discard missing rows; mean substitution that involves replacing any missing value with the mean of all other values per column; regression imputation using a regression model to predict a missing value; and zero padding to treat any missing value as zero. The approach to handle missing values is not limited to the above, and may adopt a method according to the type of observable data.

The observable data of the entire service generated by the above processing is transmitted to the processing unit 12.

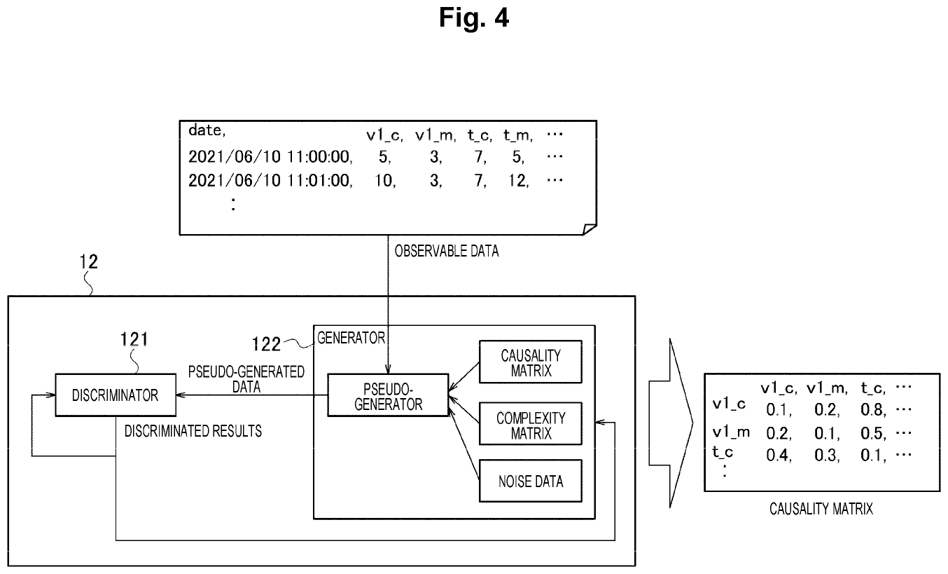

One example of an operation executed by the processing unit 12 will be described with reference to FIG. 4.

The processing unit 12 inputs the observable data of the entire service, repeats learning using a generator 122 and a discriminator 121 to update a causal structure matrix, and outputs the causal structure matrix. The observable data of the entire service is provided as an input to the generator 122. A pseudo-generator of the generator 122 generates and outputs pseudo-generated data similar to actual data from the observable data, causal structure matrix, complexity matrix and noise data for the entire service. The discriminator 121 inputs the pseudo-generated data output from the generator 122 and discriminates whether the input data is authentic or fake. The discrimination result is fed back to the generator 122 and the discriminator 121, and learning is repeated so that the accuracy of the generator 122 and the discriminator 121 is improved. The causal structure matrix is updated and grown by the learning of the generator 122.

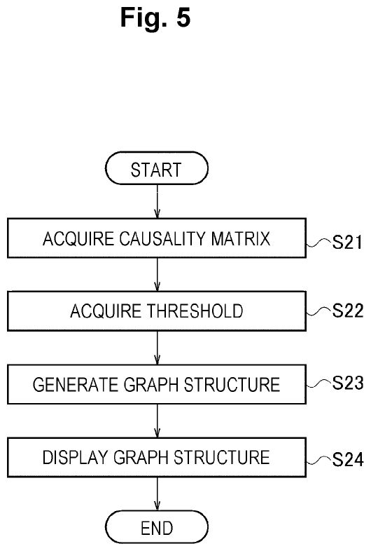

One example of an operation executed by the output unit 13 will be described with reference to a flowchart of FIG. 5.

In step S21, the output unit 13 acquires a causal structure matrix from the processing unit 12.

In step S22, the output unit 13 acquires a threshold. The threshold is set by, for example, a slide bar displayed in a display screen output by the output unit 13.

In step S23, the output unit 13 generates a graph structure in which a type of the observable data is represented by a node and a causal relationship is represented by an edge on the basis of the causal structure matrix and the threshold. In particular, the output unit 13 analyzes the causal structure matrix in units of rows, and connects the observable data in the row as a source node and the observable data in the column as a destination node with the edge for a column in which a value of the element is equal to or greater than the threshold. The element of the i-th row and the j-th column of the causal structure matrix is a numerical expression of the causal relationship existing in a direction from the observable data in the i-th row to the observable data in the j-th column. Elements of the causal structure matrix take values from 0 to 1, and it is presumed that the causal relationship exists as the value approaches 1. In a case where the element of the i-th row and the j-th column is equal to or more than the threshold, the causal structure of the observable data in the i-th row with respect to the observable data in the j-th column can be estimated.

However, in a case of DAG violation, that is, in a case where the graph structure circulates, the edge having the smallest value is omitted. DAG violation can be determined by whether topological sorting can be performed.

In step S24, the output unit 13 outputs and displays the graph structure on the display device.

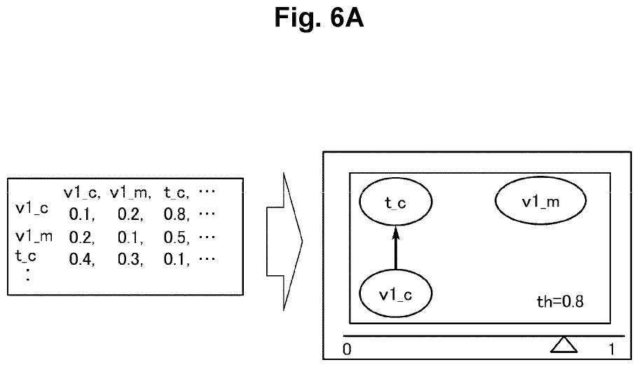

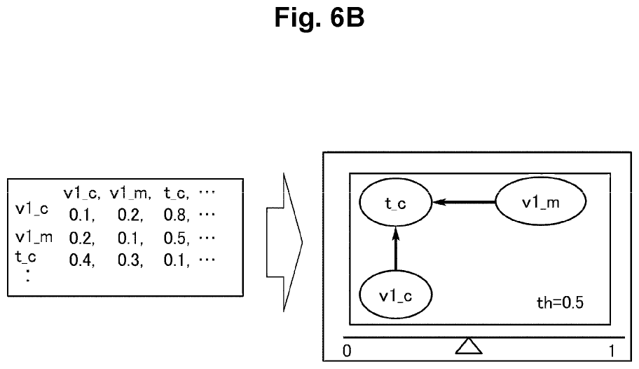

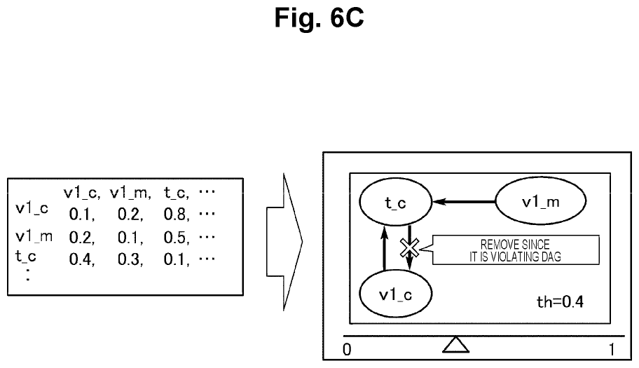

FIGS. 6A to 6C respectively illustrate one example in which the graph structure is displayed while the threshold varies. In the example of FIG. 6A, the threshold is set to 0.8. The threshold can be set by a slide bar at the bottom of the screen. Among the elements of the causal structure matrix shown in the same drawing, an element having a value of 0.8 or more is an element in the v1_c row of the t_c column. Thus, a graph structure with an edge from a node of v1_c towards a node of t_c is displayed. In FIG. 6A, a node of v1_m not connected by an edge is also displayed, but nodes not connected by an edge may not be displayed.

In the example of FIG. 6B, the threshold is set to 0.5. Elements having a value of 0.5 or more are elements in the v1_c row and the v1_m row of the t_c column. Thus, a graph structure with an edge from a node of v1_m towards a node of t_c is displayed, in addition to the edge illustrated in FIG. 6A.

In the example of FIG. 6C, the threshold is set to 0.4. Elements having a value of 0.4 or more are elements in the v1_c row and the v1_m row of the t_c column and an element in the t_c row of the v1_c column. In this case, an edge from the node of t_c to the node of v1_c is added in addition to the edge illustrated in FIG. 6B, but this is DAG violation. For the DAG violation, the edge with the smallest value is omitted. In the example of FIG. 6C, an edge from the node of t_c to the node of v1_c is removed.

By gradually decrementing the threshold from 1, the observable data having a strong causal relationship is connected by the edge in order, and the graph structure becomes larger, so that it is possible to determine the priority of the investigation targets. In the case of FIGS. 6A to 6C, since the causal structure of VM1-related metrics with respect to the CPU usage of Tomcat can be seen, it can be estimated that VM1 is a factor.

As stated above, the information processing device 1 according to the present embodiment includes: a working unit 11 configured to collect and combine various observable data acquired from a managed target at predetermined time intervals; a processing unit 12 configured to input the combined observable data and update a causal structure matrix by repeatedly learning with a generator 122 that generates pseudo-generated data using the causal structure matrix and a discriminator 121 that identifies whether the pseudo-generated data is false or not, wherein the causal structure matrix represents a causal structure between the combined observable data; and an output unit 13 configured to output the causal structure between the observable data based on the causal structure matrix. Accordingly, the maintenance personnel can identify the causal structure between the observable data and shorten the time required to investigate the cause when a failure occurs.

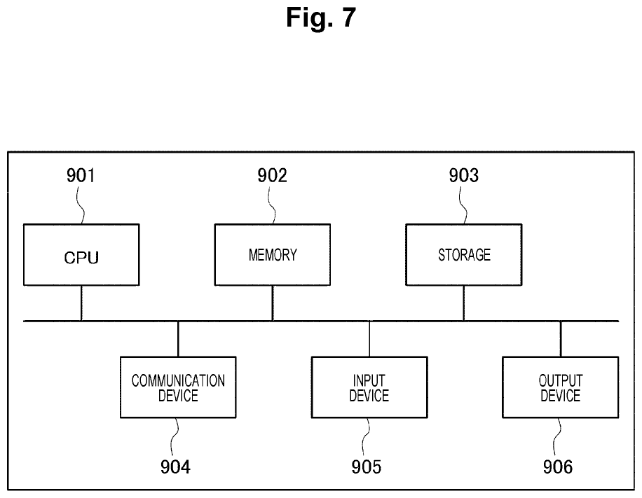

For example, as illustrated in FIG. 7, a general-purpose computer system including a central processing unit (CPU) 901, a memory 902, a storage 903, a communication device 904, an input device 905, and an output device 906 can be used as the information processing device 1 described above. In this computer system, the CPU 901 executes a predetermined program loaded on the memory 902, thereby implementing the information processing device 1. This program can be recorded on a computer-readable recording medium such as a magnetic disk, an optical disc, or a semiconductor memory, or can be distributed via a network.

### REFERENCE SIGNS LIST

1 Information processing device
11 Working unit
12 Processing unit
13 Output unit
3 Data storage unit

1. An information processing device, comprising one or more processors configured to perform operations comprising:
collecting and combining various observable data acquired from a managed target at predetermined time intervals;
inputting the combined observable data and updating a causal structure matrix by repeatedly learning with a generator that generates pseudo-observable data using the causal structure matrix and a discriminator that identifies whether the pseudo-observable data is false or not, wherein the causal structure matrix represents a causal structure between the combined observable data; and
outputting the causal structure between the observable data based on the causal structure matrix.

2. The information processing device according to claim 1, wherein the operations further comprise converting timestamp information of the observable data into time information indicating the predetermined time interval, and combining the observable data having the same time information.

3. The information processing device according to claim 1, wherein the operations further comprise converting the observable data which is a character string into a numerical value.

4. The information processing device according to claim 1, wherein the operations further comprise handling a missing value of the observable data combined at the predetermined time intervals.

5. The information processing device according to claim 1, wherein
elements of the causal structure matrix are numerical values of the causal structure between observable data in rows of the elements and observable data in columns of the elements, and
the operations further comprise outputting a directed acyclic graph in which row observable data and column observable data of the elements of the causal structure matrix are equal to or greater than a threshold and are regarded as nodes, and the nodes are connected by edges.

6. An information processing method comprising:
collecting and combining various observable data acquired from a managed target at predetermined time intervals;
inputting the combined observable data and updating a causal structure matrix by repeatedly learning with a generator that generates pseudo-observable data using the causal structure matrix and a discriminator that identifies whether the pseudo-observable data is false or not, wherein the causal structure matrix represents a causal structure between the combined observable data; and
outputting the causal structure between the observable data based on the causal structure matrix.

7. (canceled)

8. A non-transitory computer-readable medium storing program instructions that, when executed, cause one or more processors to perform operations comprising:
collecting and combining various observable data acquired from a managed target at predetermined time intervals;
inputting the combined observable data and updating a causal structure matrix by repeatedly learning with a generator that generates pseudo-observable data using the causal structure matrix and a discriminator that identifies whether the pseudo-observable data is false or not, wherein the causal structure matrix represents a causal structure between the combined observable data; and
outputting the causal structure between the observable data based on the causal structure matrix.
